(19) United States
(12) Patent Application Publication
(10) Pub. No.: US 2008/0157598 A1
(43) Pub. Date: Jul. 3, 2008

(54) Power converting apparatus

(75) Inventors: Takashi Kuitani, Tokyo (JP); Mutsumi Ishii, Tokyo (JP); Morishige Akagi, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: MITSUBISHI ELECTRIC CORP., Tokyo (JP)

(21) Appl. No.: 11/643,766

(22) Filed: Dec. 22, 2006

(30) Foreign Application Priority Data
Feb. 14, 2006 (JP) 2006-036213

(51) Int. Cl. H02J 9/00

(52) U.S. Cl. 307/45

(57) ABSTRACT

A power converting apparatus used as an uninterruptible power supply connected between an AC power supply and a load includes first and second power converters, a power supply voltage sensor, an output voltage sensor and a controller. The controller calculates rms voltage values of positive and negative half-cycles of an AC output voltage detected by the output voltage sensor, generates a target voltage command based on calculation results and a given reference voltage command, and controls the first power converter based on an output voltage command which is equivalent to a voltage difference between the AC power supply voltage detected by the power supply voltage sensor and the target voltage command.

### BACKGROUND OF THE INVENTION

1. Field of the Invention

The present invention relates generally to a power converting apparatus used as a voltage fluctuation compensator or an uninterruptible power supply, for instance, and more particularly, pertains to a power converting apparatus capable of delivering power with a stable voltage regardless of an imbalance between positive and negative voltages.

2. Description of the Background Art

As an example, Japanese Patent Application Publication No. 1999-178216 discloses a conventional uninterruptible power supply which includes a first converter connected between a direct current (DC) power storage device and a load, the first converter being capable of converting power in either a forward or reverse direction, a switch for connecting and disconnecting an alternating current (AC) power supply, and a second converter of which AC output side is series-connected to the AC power source and the switch, the second converter being capable of converting power in a reverse direction. When AC power fed from the AC power supply is normal, the switch is closed and the second converter is controlled such that the sum of an output voltage of the second converter and AC power supply voltage remains constant while the first converter is controlled to supply power to both the second converter and the DC power storage device and deliver reactive currents containing harmonic currents required by the load. When the AC power supply voltage drops to or below a minimum permissible level, the switch is opened and the first converter is controlled such that an AC voltage applied to the load remains constant.

On the other hand, Japanese Patent Application Publication No. 2005-223979 discloses another example of a conventional uninterruptible power supply which includes a converter for converting input AC power into DC power, positive- and negative-side smoothing capacitors which together constitute a series circuit connected to an output side of the converter, and an inverter for producing an AC output from an output of the series circuit of the two smoothing capacitors, and a controller. The controller makes a correction to an AC output voltage command given to the inverter according to a “DC voltage difference,” or a difference between DC voltages applied to the positive- and negative-side smoothing capacitors.

The aforementioned uninterruptible power supply of Japanese Patent Application Publication No. 1999-178216 supplies a constant voltage to the load while controllably shaping an input current into a sine wave to maintain a power factor of 1, thereby achieving a high overall system efficiency. However, if a half-wave rectifier circuit having asymmetrical positive and negative voltage characteristics is connected as a load, for example, positive and negative output voltages of the uninterruptible power supply become unbalanced. This results in a problem that this type of conventional uninterruptible power supply can not be continuously operated in a stable manner in such a situation.

The aforementioned uninterruptible power supply of Japanese Patent Application Publication No. 2005-223979 is improved to supply a stable source voltage to a load even when the load has asymmetrical positive and negative voltage characteristics. In this uninterruptible power supply, the controller corrects the AC output voltage command given to the inverter according to a DC voltage difference between the positive and negative voltages applied respectively to the positive- and negative-side smoothing capacitors that are input into the inverter. This configuration is apt to develop an occasional problem that an imbalance between positive and negative output voltages supplied to the load can not be eliminated with high accuracy due to internal errors of the controller, for example.

### SUMMARY OF THE INVENTION

Intended to overcome the aforementioned problems of the prior art, the present invention has as an object the provision of a power converting apparatus which can supply a stable voltage to a load with any imbalance between positive and negative output voltages eliminated with high accuracy even when the load has asymmetrical positive and negative voltage characteristics.

According to the invention, a power converting apparatus includes a first power converter including a single-phase inverter for converting DC power fed from a first DC power supply into AC power, an AC output side of the single-phase inverter being series-connected to an AC power supply and a load therebetween, a power supply voltage sensor for detecting a voltage fed from the AC power supply, an output voltage sensor for detecting an AC output voltage supplied to the load, and a controller. The controller includes a positive-side root-means-square (rms) voltage value calculator and a negative-side rms voltage value calculator for calculating rms voltage values of positive and negative half-cycles of the AC output voltage detected by the output voltage sensor, respectively, and a target voltage generator for generating a target voltage command based on results of calculations by the positive- and negative-side rms voltage value calculators and a given reference voltage command. The controller controls the first power converter based on an output voltage command which is equivalent to a voltage difference between the AC power supply voltage detected by the power supply voltage sensor and the target voltage command.

The power converting apparatus thus structured detects a voltage imbalance between the positive and negative half-cycles of the AC output voltage and generates the target voltage command for the voltage to be supplied to the load. This arrangement of the invention makes it possible to supply a stable voltage to the load with any voltage imbalance between the positive and negative half-cycles of the AC output voltage eliminated with high accuracy even when the load has asymmetrical positive and negative voltage characteristics.

The foregoing and other objects, features, aspects and advantages of the present invention will become more apparent from the following detailed description when read in conjunction with the accompanying drawings.

### BRIEF DESCRIPTION OF THE DRAWINGS

FIG. 1 is a circuit diagram generally showing the configuration of a power converting apparatus according to a first embodiment of the invention which is used as an uninterruptible power supply;

FIG. 2 is a circuit diagram particularly showing the configuration of a controller of the power converting apparatus of the first embodiment;

FIG. 3 is a diagram showing signal waveforms explaining the working of a first power converter of the power converting apparatus under conditions where there is no voltage imbalance;

FIG. 4 is a diagram showing signal waveforms explaining the working of the first power converter of the power converting apparatus under conditions where there is a voltage imbalance;

FIG. 5 is a truth table illustrating control operation performed by an inverter drive circuit of the power converting apparatus of the first embodiment;

FIG. 6 is a diagram illustrating current control operation performed by a second power converter of the power converting apparatus of the first embodiment;

FIG. 7 is a diagram showing output voltage waveforms of the second power converter and individual single-phase inverters thereof of the first embodiment;

FIG. 8 is a diagram showing an output current of the second power converter of the first embodiment;

FIG. 9 is a circuit diagram generally showing the configuration of a power converting apparatus according to a second embodiment of the invention which is used as an uninterruptible power supply; and

FIG. 10 is a circuit diagram generally showing the configuration of a variation of the power converting apparatus of the second embodiment of the invention which is used as an uninterruptible power supply.

### DESCRIPTION OF THE PREFERRED EMBODIMENTS

Specific embodiments of the invention will now be described, by way of example, with reference to the accompanying drawings.

### First Embodiment

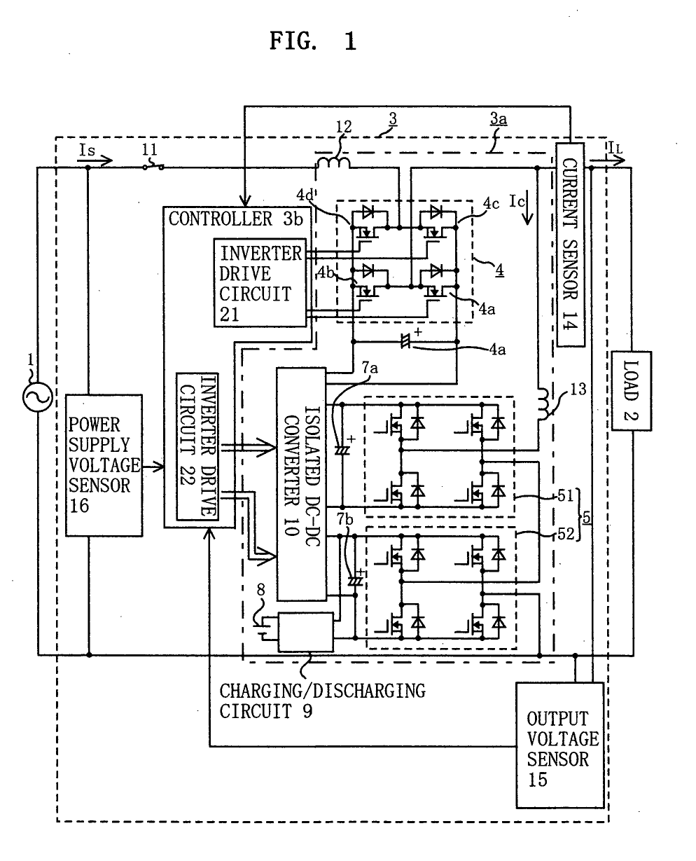

FIG. 1 is a circuit diagram generally showing the configuration of a power converting apparatus according to a first embodiment of the invention which is used as an uninterruptible power supply 3. As shown in FIG. 1, a main circuit 3a of the uninterruptible power supply 3 which is connected between an AC power supply 1 and a load 2 includes a first power converter 4 made up of a single-phase inverter and a second power converter 5 made up of a plurality of (two in this embodiment) single-phase inverters 51, 52 which are series-connected on an AC output side. An AC output side of the first power converter (single-phase inverter) 4 is series-connected to the AC power supply 1 and the load 2 therebetween, whereas the AC output side of the second power converter 5 is parallel-connected to the AC power supply 1 and the load 2 therebetween via a reactor 13. The first power converter 4 is connected between the AC power supply 1 and the load 2 at a point closer to the AC power supply 1 than a point where the second power converter 5 is connected between the AC power supply 1 and the load 2.

The uninterruptible power supply 3 further includes a switch 11 series-connected to the AC power supply 1 and the AC output side of the first power converter 4 for connecting and disconnecting the AC power supply 1, an output voltage sensor 15 for detecting an AC output voltage supplied to the load 2, a power supply voltage sensor 16 for detecting a voltage fed from the AC power supply 1, and a current sensor 14 for detecting load current IL.

Each of the aforementioned single-phase inverters 4, 51, 52 is a full-bridge inverter including a plurality of self-turn-off semiconductor switching devices, such as insulated-gate bipolar transistors (IGBTs) designated by 4a-4d, for example, each of which is connected to a diode in reverse parallel directions. It is also possible to use such devices as gate commutated turn-off (GCT) thyristors, gate turn-off (GTO) thyristors, transistors or metal-oxide-semiconductor field-effect transistors (MOSFETs) as the self-turn-off semiconductor switching devices instead of the IGBTs. Alternatively, thyristors having no self-turn-off function may be used as the switching devices provided that those thyristors have a forced commutation capability. The first and second power converters 4, 5 are controlled by a controller 3b of the uninterruptible power supply 3, the controller 3b including a pair of inverter drive circuits 21, 22 for controllably driving the individual single-phase inverters 4, 51, 52. The internal configuration of the controller 3b and control operation performed thereby will be later described in detail.

The aforementioned single-phase inverters 4, 51, 52 are associated with capacitors 6, 7a and 7b which serve as independent first and second DC power supplies for the respective single-phase inverters 4, 51, 52. Charged in polarities shown in FIG. 1, these capacitors 6, 7a, 7b can supply DC voltages to the respective single-phase inverters 4, 51, 52 for desired periods. The first power converter 4 powered by the capacitor (first capacitor) 6 serving as the first DC power supply is controlled by the controller 3b using a pulse width modulation (PWM) technique, and an AC output voltage of the first power converter 4 is connected in series with the AC power supply 1 via a filter 12. Therefore, the sum of AC power supply voltage of the AC power supply 1 and the AC output voltage of the first power converter 4 is supplied to the load 2.

The two single-phase inverters 51, 52 of the second power converter 5 are powered by the capacitors 7a, 7b which serve as the second DC power supplies, respectively. The controller 3b controls the second power converter 5 in such a way that an AC output voltage of the second power converter 5 given as the sum of output voltages of the individual single-phase inverters 51, 52 has a generally sinusoidal waveform. The second power converter 5 serves as an active filter and is controlled to generate a harmonics compensation current (inverter current IC) which cancels out harmonic current components contained in the load current IL.

Of the two capacitors 7a, 7b which supply power to the respective single-phase inverters 51, 52 of the second power converter 5, the second capacitor 7b is a maximum voltage power supply (maximum voltage capacitor) which is charged to a higher voltage than the other capacitor 7a by an external DC power supply 8 serving as a third DC power supply through a charging/discharging circuit 9 which serves as a voltage control device. The other capacitors 6, 7a for the first and second power converters 4, 5 are connected to the maximum voltage capacitor 7b through an isolated DC-DC converter 10 and controllably charged to specific voltages.

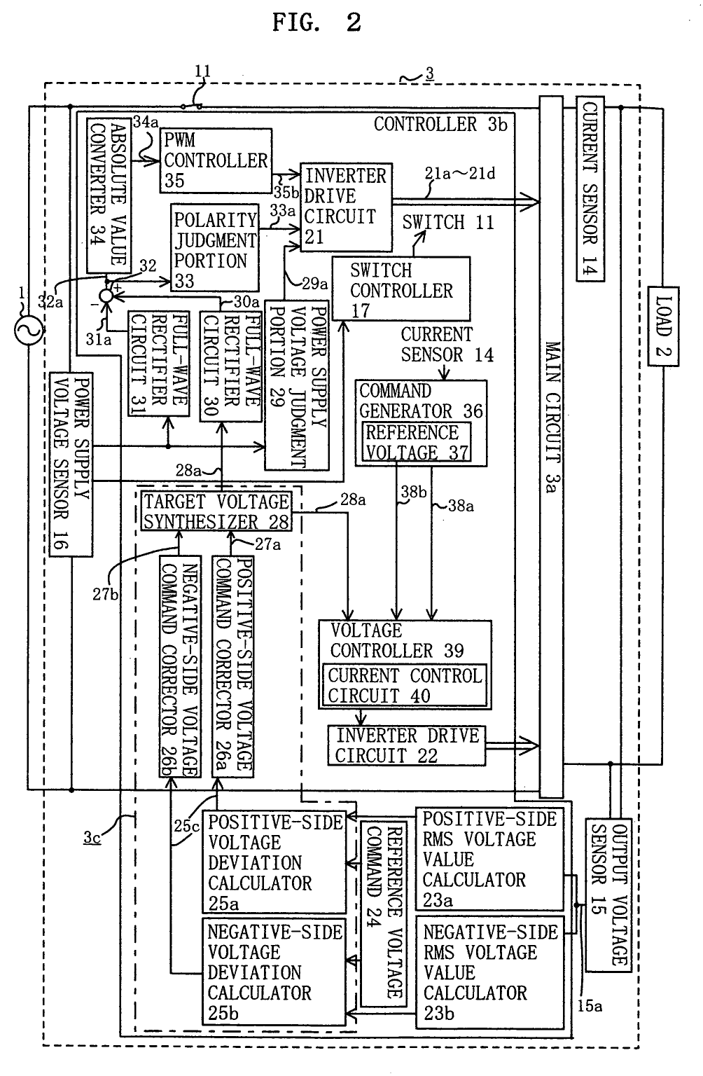

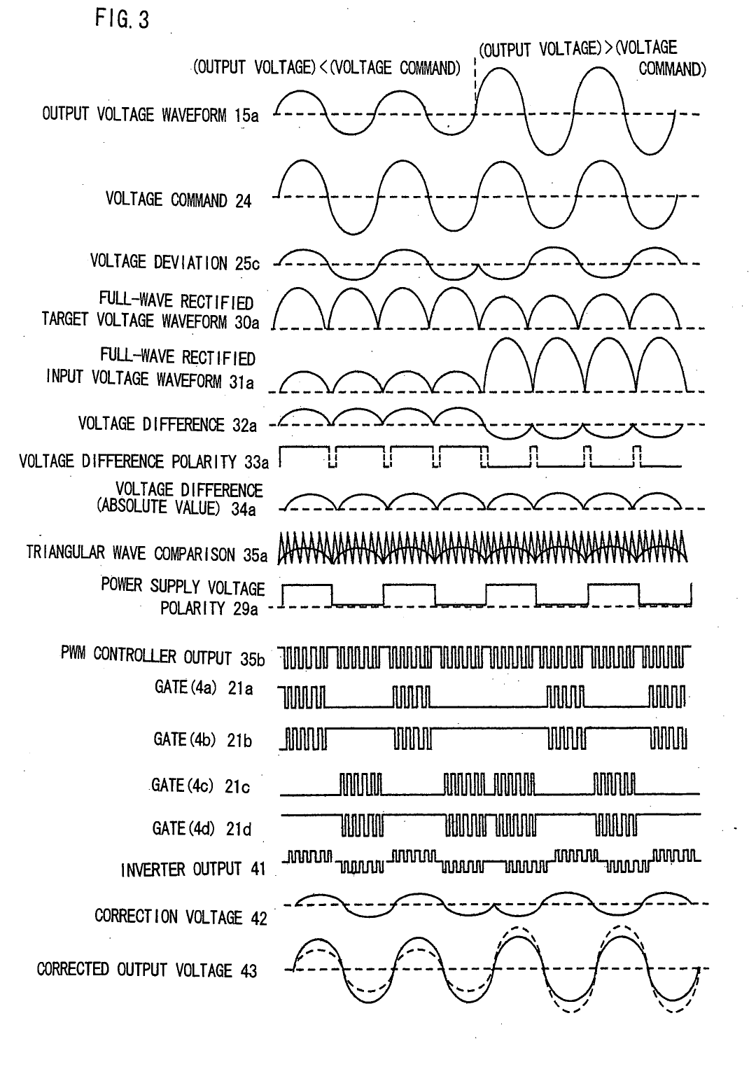

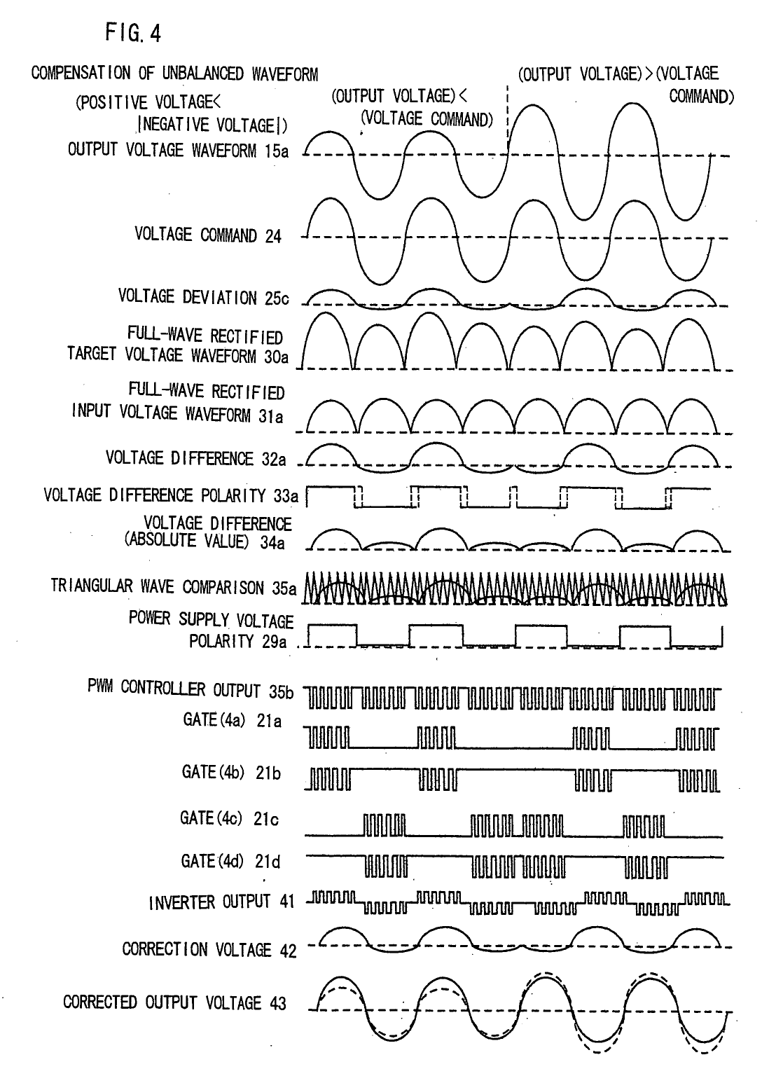

FIG. 2 is a circuit diagram particularly showing the configuration of the controller 3b of the uninterruptible power supply 3 of FIG. 1. FIGS. 3 and 4 are diagrams showing waveforms of signals which individual elements output in relation to control operation of the first power converter 4, in which shown in FIG. 3 are signal waveforms observed when there is no imbalance between positive and negative values of the AC output voltage of the uninterruptible power supply 3 supplied to the load 2, and shown in FIG. 4 are signal waveforms observed when an imbalance (positive voltage value<|negative voltage value|) occurs in the AC output voltage of the uninterruptible power supply 3 as the load 2 connected thereto has asymmetrical positive and negative voltage characteristics. First and second halves of each signal waveform shown in FIGS. 3 and 4 are what are observed when the AC output voltage is lower than a voltage command (AC output voltage<voltage command) and when the AC output voltage is higher than the voltage command (AC output voltage>voltage command), respectively.

Now, the control operation performed by the controller 3b and the working of the uninterruptible power supply 3 are described referring to FIGS. 1 to 4.

Designated by 15a in FIGS. 3 and 4 is the AC output voltage of the uninterruptible power supply 3 detected by the output voltage sensor 15. As the detected AC output voltage 15a is input into the controller 3b, a positive-side rms voltage value calculator 23a and a negative-side rms voltage value calculator 23b calculate rms voltage values of positive and negative half-cycles of the AC output voltage, respectively. Then, a target voltage generator 3c of the controller 3b generates a target voltage command 28a based on results of calculations by the positive- and negative-side rms voltage value calculators 23a, 23b and a given reference voltage command 24.

The target voltage generator 3c includes a positive-side voltage deviation calculator 25a and a negative-side voltage deviation calculator 25b for calculating positive and negative voltage deviations based on the calculation results of the positive- and negative-side rms voltage value calculators 23a, 23b and the reference voltage command 24, respectively, a positive-side voltage command corrector 26a and a negative-side voltage command corrector 26b for generating a positive target voltage 27a and a negative target voltage 27b by correcting the reference voltage command 24 for both the positive and negative half-cycles based on the positive and negative voltage deviations input from the positive- and negative-side voltage command correctors 26a, 26b, respectively, and a target voltage synthesizer 28 for generating the aforementioned target voltage command 28a by combining the positive and negative target voltages 27a, 27b and outputting the target voltage command 28a thus produced. Designated by 25c in FIGS. 3 and 4 is the waveform of a signal produced by combining the positive and negative voltage deviations output from the positive- and negative-side voltage command correctors 26a, 26b.

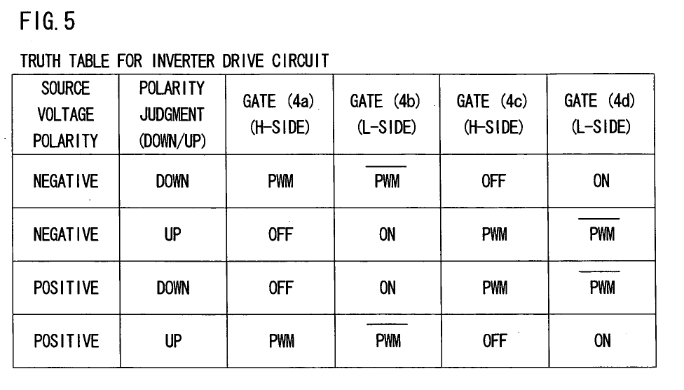

The target voltage command 28a and the AC power supply voltage detected by the power supply voltage sensor 16 are delivered to full-wave rectifier circuits 30 and 31 which produce a full-wave rectified target voltage waveform 30a and a full-wave rectified input voltage waveform 31a through full-wave rectification, respectively. These waveforms 30a, 31a are input into a subtracter 32 which produces a voltage difference signal 32a which is delivered to an absolute value converter 34. The absolute value converter 34 converts the voltage difference signal 32a into an absolute value which is input into a PWM controller 35 as a command value 34a. The PWM controller 35 generates a PWM signal 35b through a process of triangular wave comparison 35a and outputs the PWM signal 35b to the inverter drive circuit 21. The voltage difference signal 32a is also delivered to a polarity judgment portion 33 which produces a polarity signal 33a representing the polarity of the voltage difference signal 32a. The AC power supply voltage detected by the power supply voltage sensor 16 is also delivered to a power supply voltage judgment portion 29 which produces polarity signal 29a representing the polarity of the AC power supply voltage. The polarity signal 33a representing the polarity of the voltage difference signal 32a and the polarity signal 29a representing the polarity of the AC power supply voltage are input into the inverter drive circuit 21. The inverter drive circuit 21 outputs gate signals 21a-21d for controllably driving the switching devices 4a-4d of the first power converter (single-phase inverter) 4, respectively. Shown in FIG. 5 is a truth table illustrating control operation performed by the inverter drive circuit 21.

An output voltage 41 of the first power converter 4 is smoothed by the filter 12 and added to the AC power supply voltage output from the AC power supply 1 as a correction voltage 42. The sum of the AC power supply voltage and the correction voltage 42, or a corrected output voltage 43, is supplied to the load 2. As depicted in FIGS. 3 and 4, the corrected output voltage 43 supplied to the load 2 has a stable sinusoidal waveform not only when there is no imbalance of the AC output voltage 15a between positive and negative cycles but also when such an imbalance is present.

On the other hand, the load current IL detected by the current sensor 14 is input into a command generator 36 for the second power converter 5, and the command generator 36 detects harmonic current components contained in the load current IL and generates a current command 38a defining a target value of the harmonics compensation current for canceling out the harmonic current components. The command generator 36a also generates a voltage command 38b defining a reference voltage 37 which is a sinusoidal AC voltage. The current command 38a and the voltage command 38b output from the command generator 36 are fed into a voltage controller 39 which generates a control signal to be sent to the inverter drive circuit 22 for controlling the second power converter 5 such that the sum of the output voltages of the individual single-phase inverters 51, 52 of the second power converter 5 becomes generally equal to the sinusoidal reference voltage 37 defined by the voltage command 38b. Further, the voltage controller 39 includes a current control circuit 40 provided with a hysteresis comparator, for instance. The current control circuit 40 controls the inverter current IC which is an output current of the second power converter 5 to follow the aforementioned current command 38a.

Voltage and current control operation performed by the second power converter 5 is now described in detail.

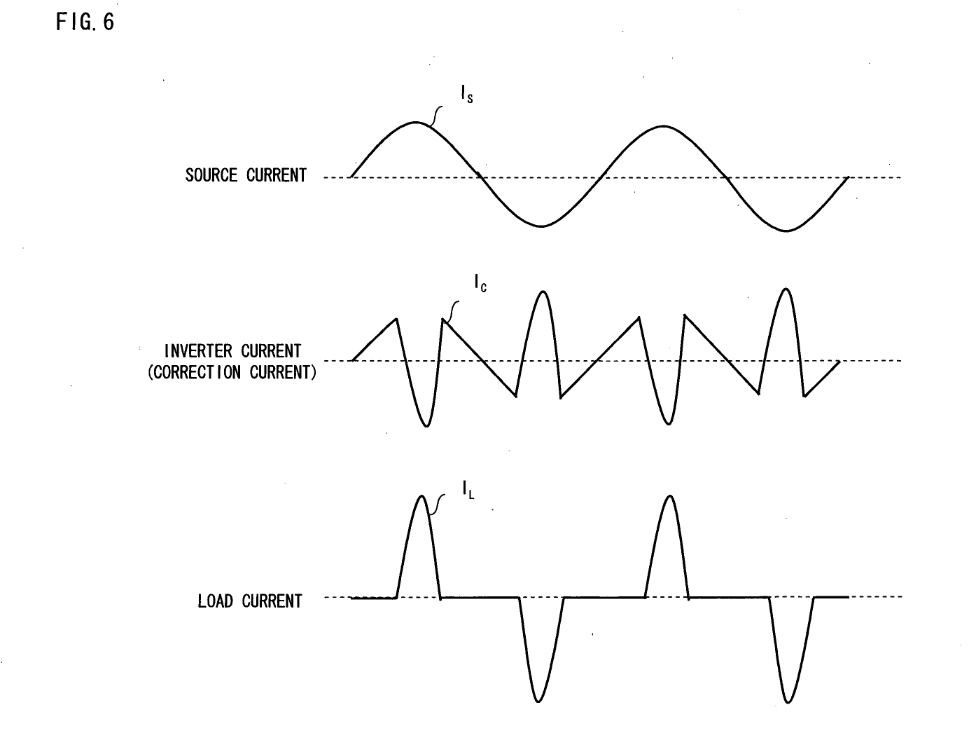

As previously mentioned, the second power converter 5 is operated as an active filter. Specifically, the second power converter 5 is controlled to generate the harmonics compensation current (inverter current IC) which cancels out the harmonic current components contained in the load current IL generated by the load 2, whereby source current is shaped into a sinusoidal current containing no harmonic current components so that a current containing harmonic components will not flow back to the power supply side, as shown in FIG. 6.

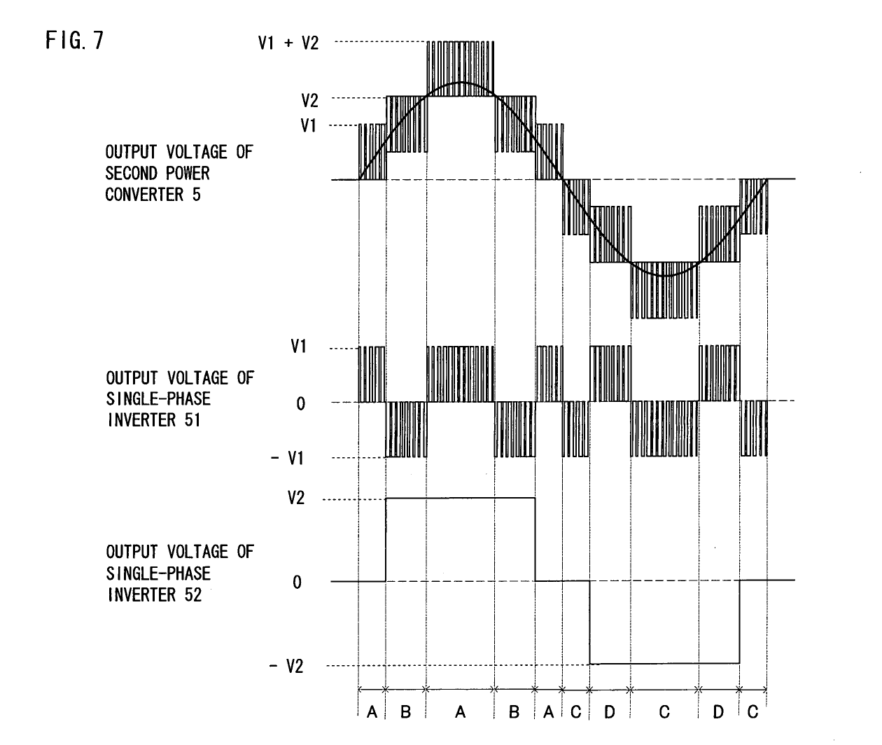

FIG. 7 is a diagram showing output voltage waveforms of the second power converter 5 and the individual single-phase inverters 51, 52 thereof. As shown in FIG. 7, the single-phase inverter 52 powered by the maximum voltage capacitor 7b alternately outputs positive-going and negative-going voltage pulses at a rate of one pulse per half cycle of the voltage command 38b defining the reference voltage 37 which is a reference AC voltage, and the single-phase inverter 51 outputs positive-going and negative-going voltage pulses having shorter pulselengths used for finely adjusting the output voltage of the second power converter 5.

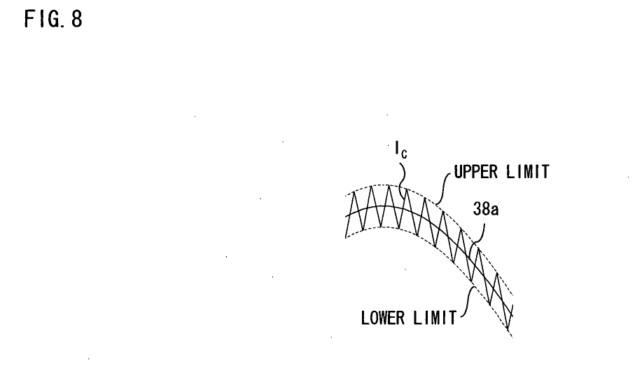

FIG. 8 is a diagram showing a waveform of the inverter current IC which is the output current of the second power converter 5. The inverter current IC is controlled to follow the current command 38a defining a target current so that the source current IS is shaped into a sinusoidal waveform. For this purpose, the controller 3b sets upper and lower limits of the inverter current IC such that the target current defined by the current command 38a is always at a midpoint between the upper and lower limits, and the controller 3b adjusts the output voltage of the single-phase inverter 51 in fine steps so that the inverter current IC varies within a range between the upper and lower limits. The single-phase inverter 51 is controlled in this way by successively switching the semiconductor switching devices, whereby the source current IS is shaped into a sinusoidal wave having a power factor of 1. As a result, the output voltage of the second power converter 5 obtained as the sum of the output voltages of the two single-phase inverters 51, 52 is controlled to have a sinusoidal waveform which is substantially equivalent to that of the reference voltage 37 defined by the voltage command 38b.

The above-described method of controlling the first and second power converters 4, 5 is applied to normal operating conditions where the output voltage of the AC power supply 1 is within a specified range between permissible limits. Under normal operating conditions where the output voltage of the AC power supply 1 detected by the power supply voltage sensor 16 is within the specified range, a switch controller 17 of the controller 3b closes the switch 11, and the first power converter 4 is controlled to output a voltage difference between the AC power supply voltage and the aforementioned target voltage command 28a while the second power converter 5 is controlled to output the harmonics compensation current for canceling out harmonics generated by the load 2.

Under abnormal operating conditions, such as a power outage, in which the output voltage of the AC power supply 1 goes beyond the permissible limits of the aforementioned specified range, the switch controller 17 opens the switch 11 to isolate the AC power supply 1 from the load 2. In this case, the AC output of the first power converter 4 is also isolated from the load 2 and the output voltage of the second power converter 5 obtained as the sum of the output voltages of the two single-phase inverters 51, 52 is supplied to the load 2 with the output voltage of the second power converter 5 controlled to have a sinusoidal waveform which is substantially equivalent to that of the reference voltage 37 defined by the voltage command 38b. In this case, the second power converter 5 does not perform any current control operation for generating the harmonics compensation current but controls the output voltage such that a stable AC voltage is supplied to the load 2.

In the first embodiment thus far discussed, the controller 3b generates the target voltage command 28a for the voltage to be supplied to the load 2 and the first power converter 4 is controlled to output the voltage difference between the AC output voltage 15a detected by the output voltage sensor 15 and the target voltage command 28a. The output voltage 41 of the first power converter 4 is smoothed by the filter 12 and added to the output voltage of the AC power supply 1, so that the sum of the AC power supply voltage and the correction voltage 42, or the corrected output voltage 43, is supplied to the load 2.

The AC output voltage 15a detected by the output voltage sensor 15 is input into the controller 3b, and the positive-side rms voltage value calculator 23a and the negative-side rms voltage value calculator 23b calculate the rms voltage values of the positive and negative half-cycles of the AC output voltage of the uninterruptible power supply 3. The target voltage generator 3c generates the target voltage command 28a based on the results of calculations by the positive- and negative-side rms voltage value calculators 23a, 23b and the given reference voltage command 24. In the uninterruptible power supply 3 of the first embodiment, the rms voltage values of the positive and negative half-cycles of the AC output voltage 15a detected by the output voltage sensor 15 are calculated to reliably detect a voltage imbalance between the positive and negative half-cycles of the AC output voltage 15a, and the target voltage generator 3c generates the target voltage command 28a for correcting the voltage to be supplied to the load 2 to cancel out the voltage imbalance. Accordingly, the above-described configuration of the first embodiment makes it possible to supply a stable AC voltage to the load 2 with any imbalance between positive and negative output voltages eliminated with high accuracy even when the load 2 connected to the uninterruptible power supply 3 has asymmetrical positive and negative voltage characteristics.

The positive and negative voltage deviations of the AC output voltage of the uninterruptible power supply 3 are calculated based on the calculation results of the positive- and negative-side rms voltage value calculators 23a, 23b and the reference voltage command 24, respectively, and the target voltage command 28a is generated with the reference voltage command 24 corrected for both the positive and negative half-cycles. The target voltage command 28a thus generated reliably reflects the detected voltage imbalance between the positive and negative half-cycles of the AC output voltage 15a and can cancel out this voltage imbalance.

Since the positive and negative target voltages 27a, 27b are generated with the reference voltage command 24 corrected for both the positive and negative half-cycles, and the target voltage command 28a is generated by combining the positive and negative target voltages 27a, 27b, it is possible to correct both the positive and negative half-cycles of the AC output voltage 15a with only one sinusoidal target voltage command 28a, allowing for easy control of the AC output voltage 15a.

In the foregoing first embodiment, the first power converter 4 compensates for fluctuations in the source voltage fed from the AC power supply 1 and the second power converter 5 generates the harmonics compensation current for preventing harmonic current components contained in the load current IL from flowing back to the power supply side. When the AC power supply 1 is abnormal, the switch controller 17 opens the switch 11 to isolate the AC power supply 1 and the second power converter 5 controls the voltage applied to the load 2.

Also, since the first power converter 4 is connected between the AC power supply 1 and the load 2 at the point closer to the AC power supply 1 than the point where the second power converter 5 is connected between the AC power supply 1 and the load 2 in the present embodiment, fluctuations in the source voltage fed from the AC power supply 1 are already compensated by the output voltage 41 of the first power converter 4 at the point where the second power converter 5 is connected, or where the harmonics compensation current generated by the second power converter 5 flows in. This configuration serves to stabilize electric potential at the connecting point of the second power converter 5 and prevent harmonic current components contained in the load current IL from flowing back to the power supply side with high reliability.

The maximum voltage capacitor 7b is charged by the external DC power supply 8 through the charging/discharging circuit 9 serving as the voltage control device and the other capacitors 6, 7a for the first and second power converters 4, 5 are connected to the maximum voltage capacitor 7b through the isolated DC-DC converter 10. This arrangement of the first embodiment serves to simplify the overall structure of the uninterruptible power supply 3 by requiring only one DC power supply 8 for supplying electric power to the individual capacitors 6, 7a, 7b of the first and second power converters 4, 5.

While the second power converter 5 is configured by the two single-phase inverters 51, 52 in the foregoing first embodiment, the second power converter 5 may be modified to include three or more single-phase inverters of which AC outputs are connected in series. Since the output voltage of the second power converter 5 is determined by the sum of the output voltages of the plurality of single-phase inverters and the output current of the second power converter 5 is controlled to follow the target current as discussed above, the invention serves to eliminate the need for a large-sized filter circuit (reactor) and provide a compactly built power converting apparatus having a simplified structure capable of controlling the output current with high speed and high precision.

Alternatively, the second power converter 5 may be configured by a high-frequency PWM inverter although this configuration requires a relatively large-sized filter circuit.

As a modified form of the first embodiment, the second power converter 5 may be eliminated such that the first power converter 4 alone works as a voltage fluctuation compensator. Although the uninterruptible power supply 3 thus modified can neither generate the harmonics compensation current nor continue to operate under abnormal conditions of the AC power supply 1, the uninterruptible power supply 3 can supply a stable voltage to the load 2 with any imbalance between positive and negative output voltages eliminated with high accuracy even when the load 2 has asymmetrical positive and negative voltage characteristics.

While the switch 11 is opened and the output voltage of the second power converter 5 is controlled to have a sinusoidal waveform which is substantially equivalent to that of the reference voltage 37 defined by the voltage command 38b when the AC power supply 1 is abnormal in the foregoing first embodiment, the uninterruptible power supply 3 of the embodiment may be modified such that the target voltage command 28a generated by the target voltage generator 3c is input into the voltage controller 39 as a command value for the output voltage of the second power converter 5. The uninterruptible power supply 3 thus modified can supply a stable voltage to the load 2 with any imbalance between positive and negative output voltages eliminated by the second power converter 5 with high accuracy even when the AC power supply 1 is abnormal. As an alternative to this modification of the embodiment, there may be provided an additional target voltage generator in the controller 3b for controlling the second power converter 5.

### Second Embodiment

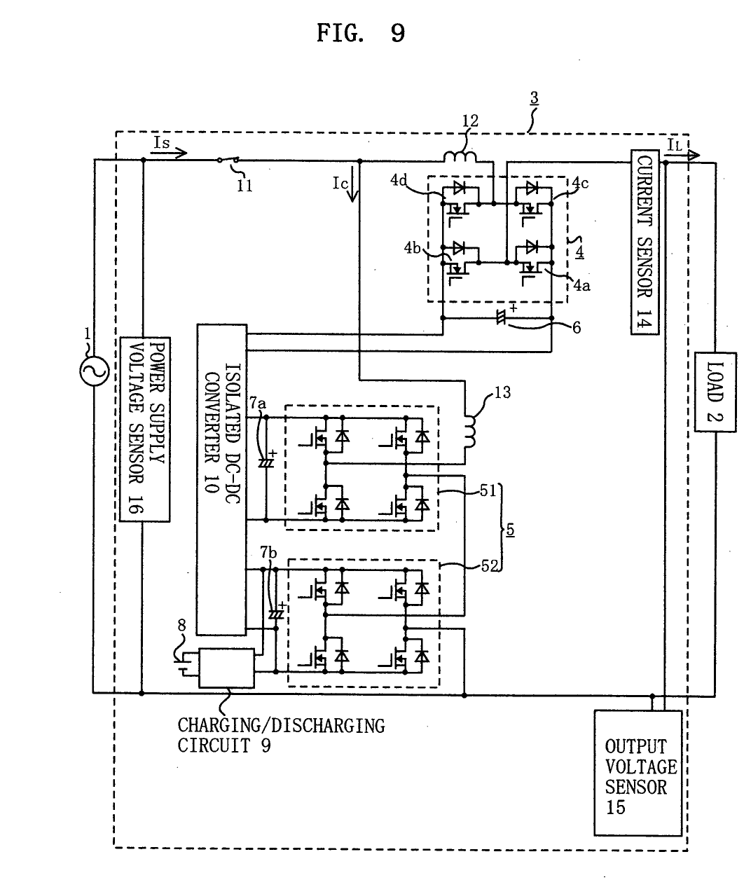

FIG. 9 is a circuit diagram generally showing the configuration of a power converting apparatus according to a second embodiment of the invention which is used as an uninterruptible power supply 3, in which elements identical or similar to those of the first embodiment are designated by the same reference numerals. While the uninterruptible power supply 3 of this embodiment is provided with a controller 3b having the same configuration as the first embodiment, the controller 3b is not shown in FIG. 9 for the sake of simplicity.

Although the first power converter 4 and the second power converter 5 are configured in the same way as in the first embodiment, the first power converter 4 is series-connected to the AC power supply 1 and the switch 11 at a point closer to the load 2 than a point where the second power converter 5 is parallel-connected to the AC power supply 1 and the load 2 in the second embodiment as shown in FIG. 9.

The uninterruptible power supply 3 of this embodiment is controlled in the same way as in the first embodiment under normal operating conditions in which the output voltage of the AC power supply 1 detected by the power supply voltage sensor 16 is within a specified range between permissible limits. Specifically, under normal operating conditions, the switch controller 17 closes the switch 11, and the first power converter 4 is controlled to output a voltage difference between the AC power supply voltage and a target voltage command 28a while the second power converter 5 is controlled to output a harmonics compensation current for canceling out harmonics generated by the load 2.

Under abnormal operating conditions, such as a power outage, in which the output voltage of the AC power supply 1 goes beyond the permissible limits of the aforementioned specified range, the switch controller 17 opens the switch 11 to isolate the AC power supply 1 from the load 2. In this case, the AC output side of the first power converter (single-phase inverter) 4 and the AC output side of the two single-phase inverters 51, 52 of the second power converter 5 are connected in series and a voltage obtained as the sum of the output voltages of all the series-connected single-phase inverters 4, 51, 52 is supplied to the load 2.

When the AC power supply 1 is abnormal, the voltage controller 39 performs “gradational output voltage control operation” using the sum of the output voltages of all the series-connected single-phase inverters 4, 51, 52 so that the uninterruptible power supply 3 can output a voltage which is substantially equivalent to the reference voltage 37 defined by a voltage command 38b. For this purpose, the voltage controller 39 transmits a control signal for the first power converter 4 to the inverter drive circuit 21 and control signals for the two single-phase inverters 51, 52 of the second power converter 5 to the inverter drive circuit 22 to controllably drive the individual single-phase inverters 4, 51, 52. In this case, the second power converter 5 does not perform any current control operation for generating the harmonics compensation current but controls the output voltage such that a stable AC voltage is supplied to the load 2.

In the above-described second embodiment, the first power converter (single-phase inverter) 4 and single-phase inverters 51, 52 of the second power converter 5 are all connected in series and the voltage obtained as the sum of the output voltages of all the series-connected single-phase inverters 4, 51, 52 is supplied to the load 2 as discussed above. This arrangement of the second embodiment makes it possible to control the AC output voltage of the uninterruptible power supply 3 with high accuracy.

The uninterruptible power supply 3 of the second embodiment may be modified such that the target voltage command 28a generated by the target voltage generator 3c is used as a command value which causes the uninterruptible power supply 3 to output a voltage substantially equivalent to that defined by the target voltage command 28a based on the sum of the output voltages of all the single-phase inverters 4, 51, 52. The uninterruptible power supply 3 thus modified can supply a stable voltage to the load 2 with any imbalance between positive and negative output voltages eliminated by the first and second power converters 4, 5 with high accuracy even when the AC power supply 1 is abnormal.

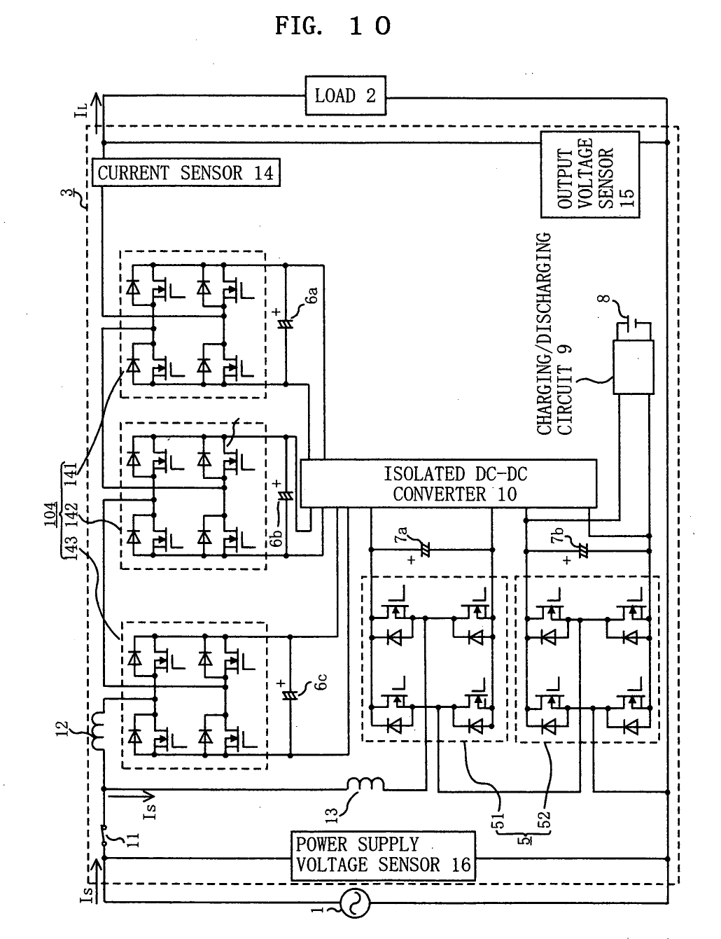

Alternatively, the uninterruptible power supply 3 of the second embodiment may be modified to include, instead of the first power converter 4, a first power converter 104 made up of a plurality of single-phase inverters 141-143 which are series-connected on the AC output side and powered by first capacitors 6a-6c serving as first DC power supplies, respectively, as shown in FIG. 10. In this modification of the second embodiment, an output voltage of the first power converter 104 is gradationally controlled based on the sum of output voltages of the plurality of single-phase inverters 141-143. This modification of the second embodiment serves to eliminate the need for a large-sized filter circuit (reactor) and provide a compactly built power converting apparatus having a simplified structure.

The first power converter 104 including the plurality of single-phase inverters 141-143 which are series-connected on the AC output side is applicable also to the earlier-described first embodiment in which the first power converter 4 is connected at the point closer to the AC power supply 1 than the point where the second power converter 5 is connected between the AC power supply 1 and the load 2, yet producing the same advantages as the first embodiment.

Various modifications and alterations of this invention will be apparent to those skilled in the art without departing from the scope and spirit of this invention, and it should be understood that this is not limited to the illustrative embodiments set forth herein.

What is claimed is:

1. A power converting apparatus comprising:
a first power converter including at least one single-phase inverter for converting DC power fed from a first DC power supply into AC power, an AC output side of the single-phase inverter being series-connected to an AC power supply and a load therebetween;
a power supply voltage sensor for detecting a voltage fed from the AC power supply;
an output voltage sensor for detecting an AC output voltage supplied to the load; and
a controller including a positive-side rms voltage value calculator and a negative-side rms voltage value calculator for calculating rms voltage values of positive and negative half-cycles of the AC output voltage detected by said output voltage sensor, respectively, and a target voltage generator for generating a target voltage command based on results of calculations by said positive- and negative-side rms voltage value calculators and a given reference voltage command;
wherein said controller controls said first power converter based on an output voltage command which is equivalent to a voltage difference between the AC power supply voltage detected by said power supply voltage sensor and the target voltage command.

2. The power converting apparatus according to claim 1, wherein said target voltage generator calculates positive and negative voltage deviations from the results of calculations by said positive- and negative-side rms voltage value calculators and the reference voltage command and generates the target voltage command by correcting the reference voltage command for both the positive and negative half-cycles based on the positive and negative voltage deviations, respectively.

3. The power converting apparatus according to claim 2, wherein said target voltage generator generates a positive target voltage and a negative target voltage by correcting the reference voltage command for both the positive and negative half-cycles, respectively, and generates said target voltage command by combining the positive and negative target voltages.

4. The power converting apparatus according to claim 1, wherein said first power converter includes a plurality of single-phase inverters which are series-connected on the AC output side and an output voltage of said first power converter is determined by the sum of output voltages of the individual single-phase inverters.

5. The power converting apparatus according to claim 1 further comprising:
a switch series-connected to the AC power supply and the AC output side of said first power converter for connecting and disconnecting the AC power supply; and
a second power converter including at least one single-phase inverter for converting DC power fed from a second DC power supply into AC power, an AC output side of the single-phase inverter being parallel-connected to the AC power supply and the load therebetween via a reactor;
wherein said controller closes said switch, controls said first power converter to output the voltage difference between the AC power supply voltage and the target voltage command as the output voltage command and controls said second power converter to output a harmonics compensation current for canceling out harmonics generated by the load under normal operating conditions where the AC power supply voltage is within a specified range between permissible limits; and
wherein said controller opens said switch and controls an output voltage of said second power converter such that a desired voltage is supplied to the load under abnormal operating conditions where the AC power supply voltage goes beyond the permissible limits of said specified range.

6. The power converting apparatus according to claim 5, wherein said second power converter includes a plurality of single-phase inverters which are series-connected on the AC output side and the output voltage of said second power converter is determined by the sum of output voltages of the individual single-phase inverters.

7. The power converting apparatus according to claim 6 further comprising:
a voltage control device through which power is supplied from a third DC power supply to a maximum voltage power supply which is one of a plurality of second DC power supplies of said second power converter and charged to a maximum voltage thereamong; and
a DC-DC converter through which the maximum voltage power supply is connected to the first DC power supply and the second DC power supplies other than the maximum voltage power supply.

8. The power converting apparatus according to claim 5, wherein said first power converter is connected between the AC power supply and the load at a point closer to the AC power supply than a point where said second power converter is connected.

9. The power converting apparatus according to claim 8, wherein said controller controls said second power converter based on an output voltage command which is equivalent to the target voltage command generated by said target voltage generator under abnormal operating conditions of the AC power supply.

10. The power converting apparatus according to claim 5, wherein said first power converter is connected between the AC power supply and the load at a point closer to the load than a point where said second power converter is connected, and the single-phase inverters of said first and second power converters are connected in series and a voltage obtained as the sum of output voltages of all the series-connected single-phase inverters is supplied to the load under abnormal operating conditions of the AC power supply.

11. The power converting apparatus according to claim 10, wherein said controller controls said second power converter such that the sum of the output voltages of all the series-connected single-phase inverters follows the target voltage command generated by said target voltage generator under abnormal operating conditions of the AC power supply.
